(19) United States
(12) Patent Application Publication
(10) Pub. No.: US 2025/0206917 A1
(43) Pub. Date: Jun. 26, 2025

(54) COMPOSITION

(71) Applicant: Merck Patent GMBH, Darmstadt (DE)

(72) Inventors: Daishi Yokoyama, Shizuoka (JP); Atsuko Noya, Shizuoka (JP); Hyun-Jin Yoon, Gyeonggi-do (KR)

(21) Appl. No.: 19/079,891

(22) Filed: Mar. 14, 2025

Related U.S. Application Data
(63) Continuation of application No. PCT/EP2023/074834, filed on Sep. 11, 2023.

(30) Foreign Application Priority Data
Sep. 14, 2022 (EP) 22195635.2

(51) Int. Cl. C08K 5/109; C08K 11/00

(52) U.S. Cl. CPC C08K 5/109; C08K 11/00

(57) ABSTRACT

The present invention relates to a composition comprising a polysiloxane.

### CROSS-REFERENCE TO RELATED APPLICATIONS

The present application is a Continuation application of International Application No. PCT/EP2023/074834, filed Sep. 11, 2023, which claims the benefit of priority of EP Application No. 22195635.2, filed Sep. 14, 2022, the entire contents of each of which is incorporated herein by reference.

### FIELD OF THE INVENTION

The present invention relates to a composition comprising at least comprising at least a polysiloxane, preferably relates to a protection layer forming composition, method for fabricating a composition, method of fabricating a layer, a layer, an electronic device, method of using a chemical compound and method of using a composition as a protection layer.

### BACKGROUND ART

US 2010/0016488 A1 discloses a process for producing an organosiloxane polymer comprising hydrolyzing tri- and tetraalkoxysilane monomers in a hydrolysis step; and polymerizing said hydrolyzed monomers in a polymerization step by subjecting them to conditions conducive to polymerization to form an organosiloxane polymer; wherein the hydrolysis step is conducted in a reaction medium comprising an organic compound with hydroxy groups. It also discloses use of a composition produced by a process for optical and electrical coatings.

### PATENT LITERATURE

US 2010/0016488 A1

### SUMMARY OF THE INVENTION

However, the inventors newly have found that there are still one or more of considerable problems for which improvement is desired, as listed below:
obtaining a polysiloxane containing composition, preferably being a protection layer forming composition, showing an improved dielectric constant like glass substrate of an electronic device, preferably with lowest haze property; obtaining a layer or cured composition, showing an improved dielectric constant like glass substrate of an electronic device, preferably with lowest haze property; obtaining a polysiloxane containing composition, preferably being a protection layer forming composition, enabling sufficient amount of thiol well dispersed in the composition; obtaining a layer or cured composition, in which sufficient amount of thiol well dispersed in the layer or cured composition; obtaining a polysiloxane containing composition, preferably being a protection layer forming composition, enabling mild or lower temperature process to form a layer or cured composition, smooth coating of polysiloxane containing composition onto any substrate, namely onto PET, CPI, COP or a polarizer.

The inventors aimed to solve one or more of the above-mentioned problems.

Then it is found as claimed, a novel composition, preferably being a protection layer forming composition, comprising at least, essentially consisting of or consisting of;
a polysiloxane; and
a chemical compound represented by following chemical formula (I). preferably it is a dielectric constant promoter preferably used for a polysiloxane containing composition,

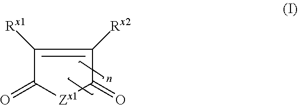

wherein
Z^{X1} is selected from the group consisting of a direct bond, CH₂, C═O, O, (C=O)₂, (C=O)O, (C=O)₃, (C=O)₂O, (C=O)₂CH₂ and C═O(CH₂)₂, preferably it is selected from a direct bond, C═O, O, (C=O)₂, (C=O)₃;
n is 0 or 1;
R^{x1} is H, D or OR^{x3};
R^{x2} is H, D or OR^{x3};
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, V⁺. Preferably said monovalent metal cation is Na⁺, Li⁺, K⁺, Cu⁺, Ag⁺, Au⁺, more preferably it is Na⁺, Li⁺, K⁺.

In another aspect, the present invention relates to a method of fabricating the composition of any one of the preceding claims, comprising at least the step of,
(I^{x}) mixing a polysiloxane and a chemical compound represented by the chemical formula (I).

In another aspect, the present invention relates to a composition obtained or obtainable by the method of the present invention.

In another aspect, the present invention relates to a method of fabricating a layer comprising at least, essentially consisting of or consisting of, the following steps;
(I^{Y}) providing the composition of the present invention, preferably onto a substrate, a supporting layer or onto a layer of an electronic device;
(II^{Y}) heating the provided composition to form a layer, preferably to remove a solvent in the composition.

In another aspect, the present invention relates to a layer obtained from the composition of the present invention by curing or obtained by the method of the present invention.

In another aspect, the present invention relates to a layer comprising at least, essentially consisting of or consisting of;
a polymer made from a polysiloxane; and
a chemical compound represented by the chemical formula (I).

In another aspect, the present invention relates to an electronic device comprising at least a layer of the present invention.

In another aspect, the present invention further relates to a method of using the chemical compound of chemical formula (I) as a dielectric constant promoter in a polysiloxane containing composition.

In another aspect, the present invention further relates to a method of using of the composition of the present invention as a protection layer forming composition for an electronic device.

Further advantages of the present invention will become evident from the following detailed description.

### Definition of the Terms

In the present specification, symbols, units, abbreviations, and terms have the following meanings unless otherwise specified.

In the present specification, unless otherwise specifically mentioned, the singular form includes the plural form and “one” or “that” means “at least one”. In the present specification, unless otherwise specifically mentioned, an element of a concept can be expressed by a plurality of species, and when the amount (for example, mass % or mol %) is described, it means sum of the plurality of species. “and/or” includes a combination of all elements and also includes single use of the element.

In the present specification, when a numerical range is indicated using “to” or “−”, it includes both endpoints and units thereof are common. For example, 5 to 25 mol % means 5 mol % or more and 25 mol % or less.

In the present specification, the hydrocarbon means one including carbon and hydrogen, and optionally including oxygen or nitrogen. The hydrocarbyl group means a monovalent or divalent or higher valent hydrocarbon. In the present specification, the aliphatic hydrocarbon means a linear, branched or cyclic aliphatic hydrocarbon, and the aliphatic hydrocarbon group means a monovalent or divalent or higher valent aliphatic hydrocarbon. The aromatic hydrocarbon means a hydrocarbon comprising an aromatic ring which may optionally not only comprise an aliphatic hydrocarbon group as a substituent but also be condensed with an alicycle. The aromatic hydrocarbon group means a monovalent or divalent or higher valent aromatic hydrocarbon. Further, the aromatic ring means a hydrocarbon comprising a conjugated unsaturated ring structure, and the alicycle means a hydrocarbon having a ring structure but comprising no conjugated unsaturated ring structure.

In the present specification, the alkyl means a group obtained by removing any one hydrogen from a linear or branched, saturated hydrocarbon and includes a linear alkyl and branched alkyl, and the cycloalkyl means a group obtained by removing one hydrogen from a saturated hydrocarbon comprising a cyclic structure and optionally includes a linear or branched alkyl in the cyclic structure as a side chain.

In the present specification, the aryl means a group obtained by removing any one hydrogen from an aromatic hydrocarbon. The alkylene means a group obtained by removing any two hydrogens from a linear or branched, saturated hydrocarbon. The arylene means a hydrocarbon group obtained by removing any two hydrogens from an aromatic hydrocarbon.

In the present specification, when polymer has a plural types of repeating units, these repeating units copolymerize. These copolymerization are any of alternating copolymerization, random copolymerization, block copolymerization, graft copolymerization, or a mixture of any of these.

In the present specification, Celsius is used as the temperature unit. For example, 20° C., 20 degrees means 20 degrees Celsius.

### DETAILED DESCRIPTION OF THE INVENTION

According to the present invention, in one aspect, the composition, preferably being a protection layer forming composition, comprises at least, essentially consisting of or consisting of;
a polysiloxane; and
a chemical compound represented by following chemical formula (I). preferably it is a dielectric constant promoter preferably used for a polysiloxane containing composition,

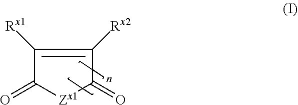

wherein
Z^{X1} is selected from the group consisting of a direct bond, CH₂, C═O, O, (C=O)₂, (C=O)O, (C=O)₃, (C=O)₂O, (C=O)₂CH₂ and C═O(CH₂)₂, preferably it is selected from a direct bond, C═O, O, (C=O)₂, (C=O)₃;
n is 0 or 1;
R^{x1} is H, D or OR^{x3};
R^{x2} is H, D or OR^{x3};
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, V*. Preferably said monovalent metal cation is Na⁺, Li⁺, K⁺, Cu⁺, Ag⁺, Au⁺, more preferably it is Na⁺, Li⁺, K⁺.

### Composition

In a preferable embodiment of the present invention, the dielectric constant (εᵣ) of the solid content of the composition is 3.5 or more, and 7 or less, preferably it is 3.9 or more, to 6.5, more preferably 4.0 or more, preferably it is 6.5 or less, more preferably 6 or less. Preferably said dielectric constant (εᵣ) of the solid content of the composition is measured by the following method from the view point of realizing high dielectric constant of the composition and an obtained layer.

According to the present invention, said dielectric constant (εᵣ) of the solid content of the composition is measured by the following method.
1) Sample preparation and mesurement of dielectric constant
Coating said composition on a conductive wafer selected from Al, Si or Mo;
Putting electrodes on the coated composition using Ag or Al by sputtering or vapor deposition to form a sample;
Measuring the dielectric constant of the sample by attaching of pin probers to the surface of the conductive wafer and the top electrode on coated composition respectively.
2) Measurement conditions; The dielectric constant is measured by LCR meter (E4980A, Agilent (Korea)/6440B, Toyo technical (Japan) with applying specific range of frequency (50^{˜}1 MHz) at room temperature and reading the capacitance indicated in the LCR meter. The value of dielectric constant is calculated by next equation, C=KA/d (C=Capacitance, K=Dielectric constant, A=Effective area of electrode, d=Distance between electrodes).

### ii) Chemical Compound of Formula (I)

According to the present invention, any publicly available chemical compound represented by the chemical formula (I) can be used.

It is believed that such chemical compound forms two-dimensional structure in and/or on film surface and provide higher dielectric constant, and/or such chemical compound regularly aligned by the effective of strong hydro bonding conjugation.

Preferably the molecular weight (Mw) of the chemical compound is 250 or less, preferably in the range from 30 to 250, more preferably from 100 to 200.

It is believed that above mentioned molecular weight can realize improved dispersity of the chemical compound of formula (I) in a polysiloxane and good compatibility with polysiloxane. And it may lead lower haze value of the composition and a layer obtained from the composition.

In a preferable embodiment of the present invention, the total amount of the chemical compound of formula (I) based on the total amount of the polysilazane in the composition is in the range from 0.01 to 40 wt %, preferably it is in the range from 0.1 to 20 wt %, more preferably from 0.5 to 5.0 wt %.

It is believed that the above mentioned total amount of the chemical compound of formula (I) based on the total amount of the polysiloxane in the composition can realize further improved dispersibility of the chemical compound of formula (I) in the composition and obtained layer with lower haze value of the layer obtained from the composition with optimal high value of the dielectric constant of the composition and the obtained layer like a Glass substrate.

According to the present invention, preferably
Z^{X1} of formula (I) is selected from a direct bond, C═O, O, (C=O)₂, (C=O)₃;
n is 0 or 1;
R^{x1} is H or OR^{x3};
R^{x2} is H or OR^{x3};
R^{x3} is H, a non-substituted or substituted straight alkyl group having 1 to 3 carbon atoms or a monovalent metal cation selected from the group consisting of Na⁺, Li⁺, K⁺, Cu⁺, Ag⁺, Au⁺, more preferably it is Na⁺, Li⁺, K⁺;
preferably said chemical compound is an oxocabonic acid selected from deltic acid, squaric acid, croconic acud, rhodizonic acid or heptagonic acid, preferably said oxocabonic acid is squaric acid or Croconic acid; an oxocabonic acid derivative, preferably said oxocabonic acid derivative is 3,4-Dihydroxy-3-cyclobutene-1,2-dione (squaric acid diethyl ester); 3,4-Dibutoxy-3-cyclobutene-1,2-dione (squaric acid dibuthyl ester), croconic acid disodium salt, potassium rhodizonate; Maleic anhydride or a combination of any of them.

### Polysiloxane

According to the present invention, any publicly available polysiloxane can be used. Preferably the polysiloxane comprises a repeating unit of chemical formula (I^{a}).

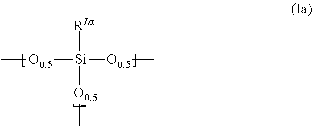

wherein
R^{Ia} is hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group, the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced, or one or more methylene is replaced by oxy, imino or carbonyl, provided that R^{Ia} is neither hydroxy nor alkoxy.

Here, the above-described methylene also includes a terminal methyl. Further, the above-described “substituted with fluorine, hydroxy or alkoxy” means that a hydrogen atom directly bonded to a carbon atom in an aliphatic hydrocarbon group and aromatic hydrocarbon group is replaced with fluorine, hydroxy or alkoxy. In the present specification, the same applies to other similar descriptions.

In a more preferable embodiment of the present invention, in the repeating unit represented by the formula (I^{a}), R^{Ia} includes, for example, (i) alkyl, such as methyl, ethyl, propyl, butyl, pentyl, hexyl, heptyl, octyl and decyl, (ii) aryl, such as phenyl, tolyl and benzyl, (iii) fluoroalkyl, such as trifluoromethyl, 2,2,2-trifluoroethyl and 3,3,3-trifluoropropyl, (iv) fluoroaryl, (v) cycloalkyl, such as cyclohexyl, (vi) a nitrogen-containing group having an amino or imide structure, such as isocyanate and amino, and (vii) an oxygen-containing group having an epoxy structure, such as glycidyl, or an acryloyl structure or a methacryloyl structure. It is preferably methyl, ethyl, propyl, butyl, pentyl, hexyl and phenyl. The compound wherein R^{Ia} is methyl is preferred, since raw material thereof is easily obtained, its film hardness after curing is high and it has high chemical resistance. Further, the compound wherein R^{Ia} is phenyl is preferred since it increases solubility of the polysiloxane in the solvent and the cured film becomes hardly crackable.

In a preferred embodiment of the present inventions, the polysiloxane used in the present invention may further comprise a repeating unit represented by formula (I^{b}):

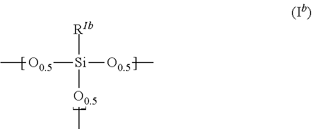

wherein
R^{Ib} is a group obtained by removing plural hydrogen from a nitrogen and/or oxygen-containing cycloaliphatic hydrocarbon compound having amino, imino and/or carbonyl.

In the formula (Ib), R^{Ib} is preferably a group obtained by removing plural hydrogen, preferably two or three hydrogen, from preferably a nitrogen-containing aliphatic hydrocarbon ring having imino and/or carbonyl, more preferably a 5-membered or 6-membered ring containing nitrogen as a member. For example, groups obtained by removing two or three hydrogen from piperidine, pyrrolidine or isocyanurate. R^{Ib} connects Si each other included in plural repeating units.

In a preferable embodiment of the present invention, the polysiloxane used in the present invention may further comprise a repeating unit represented by the formula (I^{c}):

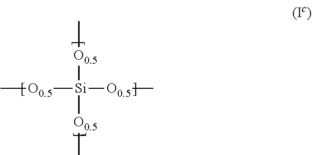

When the mixing ratio of the repeating units represented by the formulae (I^{b}) and (I^{c}) is high, compatibility with solvents and additives decreases, and the film stress increases so that cracks sometimes easily generate. Therefore, it is preferably 40 mol % or less with, more preferably 20 mol % or less, based on the total number of the repeating units of the polysiloxane.

According to the present invention, in some embodiments, the polysiloxane used in the present invention may further comprise a repeating unit represented by the formula (I^{d}):

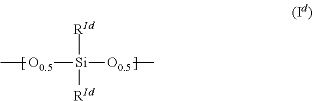

wherein
R^{Id} each independently represents hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group;
the aliphatic hydrocarbon group and the aromatic hydrocarbon group are each unsubstituted or substituted with fluorine, hydroxy or alkoxy, and in the aliphatic hydrocarbon group and the aromatic hydrocarbon group, methylene is not replaced or replaced with oxy, imide or carbonyl.

In the repeating unit represented by the formula (I^{d}), R^{Id} includes, for example, (i) alkyl, such as methyl, ethyl, propyl, butyl, pentyl, hexyl, heptyl, octyl and decyl, (ii) aryl, such as phenyl, tolyl and benzyl, (iii) fluoroalkyl, such as trifluoromethyl, 2,2,2-trifluoroethyl and 3,3,3-trifluoropropyl, (iv) fluoroaryl, (v) cycloalkyl, such as cyclohexyl, (vi) a nitrogen-containing group having an amino or imide structure, such as isocyanate and amino, and (vii) an oxygen-containing group having an epoxy structure, such as glycidyl, or an acryloyl structure or a methacryloyl structure. It is preferably methyl, ethyl, propyl, butyl, pentyl, hexyl and phenyl. The compound wherein R^{Id} is methyl is preferred, since raw material thereof is easily obtained, its film hardness after curing is high and it has high chemical resistance. Further, the compound wherein R^{Id} is phenyl is preferred since it increases solubility of the polysiloxane in the solvent and the cured film becomes hardly crackable.

By having the repeating unit of the above formula (I^{d}), it is possible to make the polysiloxane according to the present invention partially of a linear structure.

However, since heat resistance is reduced, it is preferable that portions of linear structure are few. In particular, the repeating unit of the formula (I^{d}) is preferably 30 mol % or less, more preferably 5 mol % or less, based on the total number of the repeating units of the polysiloxane. It is also one aspect of the present invention to have no repeating unit of the formula (I^{d}) (0 mol %).
the polysiloxane further comprises a repeating unit of chemical formula (I^{e}).

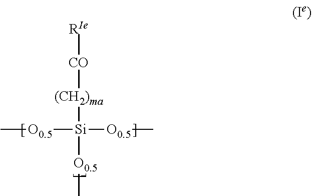

wherein
R^{Ie} is a linear alkyl group having 1-5 carbon atoms, a branched alkyl group having 3 to 7 carbon atoms, where one or more non adjacent CH₂ group of the linear alkyl group or the branched alkyl group may be replaced by C═CH₂, C═O, or OH or the terminal CH₃ group of said linear alkyl group having 1-5 carbon atoms or the branched alkyl group having 3 to 7 carbon atoms may be replaced with C═CH₃, preferably R^{Ie} is a linear alkyl group having 1-4 carbon atoms, a branched alkyl group having 3 to 5 carbon atoms, more preferably it is a branched alkyl group having 3 to 5 carbon atoms, furthermore preferably it is a branched alkyl group having 3 carbon atoms,
more preferably at least one of CH₂ groups of said linear alkyl group having 1-5 carbon atoms or the branched alkyl group having 3 to 7 carbon atoms is replaced by C═CH₂ or the terminal CH₃ group of said linear alkyl group having 1-5 carbon atoms or the branched alkyl group having 3 to 7 carbon atoms may be replaced with C═CH₃, furthermore preferably R^{Ie} is C═CH₃ or C═CH₂—CH₃,
the most preferably, said chemical formula (I^{e}) is

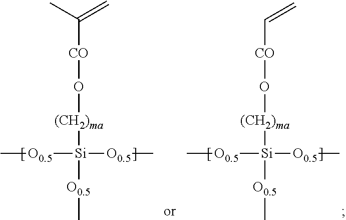

ma is each independently an integer of 1 to 6, preferably it is 2 to 5, more preferably it is 3.

It is believed that such acrylic function substituted siloxane polymer may lead higher dielectric constant. In other words, siloxane polymer containing the repeating unit of formula (I^{e}) may lead higher dielectric constant. As the siloxane polymer containing the repeating unit of formula (Ie), publicly available one can be used preferably. Such as a siloxane polymer from Torey fine chemical, a siloxane polymer from Merck,

The polysiloxane used in the present invention may contain two or more types of the repeating units mentioned above. For example, it can contain three types of repeating units having repeating units represented by the formula (Ia) in which R^{Ia} is methyl or phenyl and a repeating unit represented by the formula (I^{c}).

In addition, the polysiloxane used in the composition according to the present invention preferably has silanol. Here, the silanol refers to one in which an OH group is directly bonded to the Si skeleton of polysiloxane and is one in which hydroxy is directly attached to a silicon atom in the polysiloxane comprising repeating units such as the above formulae (I^{a}) to (I^{d}). That is, the silanol is composed by bonding —O0.5H to −O0.5—in the above formulae (I^{a}) to (I^{d}). The content of the silanol in polysiloxane varies depending on the conditions for synthesizing polysiloxane, for example, the mixing ratio of the monomers, the type of the reaction catalyst and the like.

The content of this silanol can be evaluated by quantitative infrared absorption spectrum measurement. The absorption band assigned to silanol (SiOH) appears as an absorption band having a peak in the range of 900±100 cm⁻¹ in the infrared absorption spectrum. When the content of the silanol is high, the intensity of this absorption band increases.

It is believed that highly silanol remained siloxane polymer is effective for well dispersing the chemical compound of formula (I) in a composition/obtained film.

In the present invention, in order to quantitatively evaluate the silanol content, the intensity of the absorption band assigned to Si—O is used as a reference. An absorption band having a peak in the range of 1100±100 cm¹ is adopted as a peak assigned to Si—O. The silanol content can be relatively evaluated by the ratio S2/S1, which is a ratio of the integrated intensity S2 of the absorption band assigned to SiOH to the integrated intensity SI of the absorption band assigned to Si—O. In the present invention, the ratio S2/S1 is preferably 0.003 to 0.15, more preferably 0.01 to 0.10.

The integrated intensity of the absorption band is determined in consideration of noise in the infrared absorption spectrum. In a typical infrared absorption spectrum of polysiloxane, an absorption band assigned to Si—OH having a peak in the range of 900±100 cm⁻¹ and an absorption band assigned to a Si—O having a peak in the range of 1100±100 cm⁻¹ are confirmed. The integrated intensity of these absorption bands can be measured as an area in consideration of a baseline in which noise and the like are considered. Incidentally, there is a possibility that the foot of the absorption band assigned to Si—OH and the foot of the absorption band assigned to Si—O are overlapped; however, in such a case, the wavenumber corresponding to the minimal point between the two absorption bands in the spectrum is set as their boundary. The same applies to the case where the foot of the other absorption band overlaps with the foot of the absorption band assigned to Si—OH or Si—O.

The mass average molecular weight of the polysiloxane used in the present invention is not particularly limited. However, the higher the molecular weight, the more the coating properties tend to be improved. On the other hand, the lower the molecular weight is, the less synthesis conditions are limited, so that the synthesis is easy, and the synthesis of polysiloxane having a remarkably high molecular weight is difficult. For these reasons, the mass average molecular weight of polysiloxane is usually 500 to 25,000, and preferably 1,000 to 20,000 from the viewpoint of solubility in an organic solvent. Here, the mass average molecular weight means a mass average molecular weight in terms of polystyrene, which can be measured by the gel permeation chromatography based on polystyrene.

As stated above, publicly available polysiloxane falls under above definitions can be used preferably for examples like described in WO 2021/099236 A1, EP 3717966 B1.

### Solvent

In a preferred embodiment of the present invention, the composition may further comprises a solvent from the view point of improved handling, coating, coating of the composition when string it or when fabricating a layer. Or from the viewpoint of providing solventless composition, the composition contains solvent 5 wt % or less based on the total amount of polysiloxane of the composition, preferably the composition does not contain any solvent.

Preferably said solvent is selected from one or more members of the group consisting of propylene glycol monomethyl ether acetate, propylene glycol monomethyl ether, propylene glycol diacetate, diethylene glycol monohexyl ether and methyl 3-methoxypropionate, methyl isobutyl ketone, methyl ethyl ketone, amine type solvent preferably selected from one or more members of the group consisting of N-Methylpyrrlidone (NMP), 3-Methoxy-N,N-dimethylpropanamide, N,N-dimethylacetamide (DMA), N,N-dimethylformamide (DMF), dimethyl sulfoxide (DMSO), Hexamethylphosphoric triamide (HMPA), acetonitrile, more preferably it is N-Methylpyrrlidone (NMP) or 3-Methoxy-N,N-dimethylpropanamide.

It is believed that above selected solvents have good compatibility with the composition, boiling points, viscosity and/or vapor pressure, realizing better handling of the composition, suitable for lower temperature fabrication of the layer and/or realizing an easy fabrication.

It is believed that an amine type solvent, preferably non-protic polar solvents, preferably selected from one or more members of the group consisting of N-Methylpyrrlidone (NMP), 3-Methoxy-N,N-dimethylpropanamide, N,N-dimethylacetamide (DMA), N,N-dimethylformamide (DMF), dimethyl sulfoxide (DMSO), Hexamethylphosphoric triamide (HMPA), acetonitrile, more preferably it is N-Methylpyrrlidone (NMP) or 3-Methoxy-N,N-dimethylpropanamide; can improve dispersibility of the chemical compound of formula (I) in the polymer composition and/or in a obtained layer.

Thus, in a preferable embodiment of the present invention, said solvent contains at least one amine type solvent selected from one or more members of the group consisting of N-Methylpyrrlidone (NMP), 3-Methoxy-N,N-dimethylpropanamide, N,N-dimethylacetamide (DMA), N,N-dimethylformamide (DMF), dimethyl sulfoxide (DMSO), Hexamethylphosphoric triamide (HMPA), acetonitrile, preferably the amine type solvent is N-Methylpyrrlidone (NMP) or 3-Methoxy-N,N-dimethylpropanamide.

Preferably, said solvent may further contains another solvent selected from one or more members of the group consisting of propylene glycol monomethyl ether acetate, propylene glycol monomethyl ether, propylene glycol diacetate, diethylene glycol monohexyl ether and methyl 3-methoxypropionate, methyl isobutyl ketone, methyl ethyl ketone and γ-butyrolactone.

In a preferred embodiment of the present invention, the total amount of the solvent based on the total amount of polysiloxane is 0 to 300 wt %. When the composition contains a solvent, preferably from 0.1 to 150 wt %, more preferably from 10 to 90 wt %.

### Additives

In some embodiments of the present invention, optionally, the composition may further comprise one or more of additives. Such additive may be selected from one or more members of the group consisting of, for examples, surfactants, adhesion promoter, silane coupling agent, thermal acid generators, thermal base generators, crosslinkable monomers and polymerization initiators. Publicly available ones can be used preferably, like described in EP 3717966 A1 or WO 2021/099236 A1. Since said additive is not mandatory for this invention, the amount of the additive in the composition or in the layer based on the total amount of polysiloxane is preferably 5 wt % or less, more preferably 1 wt % or less. The composition and/or a layer obtained from the composition may not contain any said additives.

In another aspect, the present invention further relates to a method of fabricating the composition of the present invention, comprising at least, essentially consisting of or consisting of; the step of,
(I^{x}) mixing a polysiloxane; and
a chemical compound represented by following chemical formula (I). preferably it is a dielectric constant promoter preferably used for a polysiloxane containing composition,

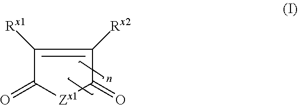

wherein
Z^{X1} is selected from the group consisting of a direct bond, CH₂, C═O, O, (C=O)₂, (C=O)O, (C=O)₃, (C=O)₂O, (C=O)₂CH₂ and C═O(CH₂)₂, preferably it is selected from a direct bond, C═O, O, (C=O)₂, (C=O)₃;
n is 0 or 1;
R^{x1} is H, D or OR^{x3};
R^{x2} is H, D or OR^{x3};
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, V*. Preferably said monovalent metal cation is Na⁺, Li⁺, K⁺, Cu⁺, Ag⁺, Au⁺, more preferably it is Na⁺, Li⁺, K⁺.

The detailed explanation of the chemical compound and polysiloxane, including preferable amounts, are indicated above in the section of ii) Chemical compound of formula (I), and i) Polysiloxane.

In another aspect, the present invention further relates to a composition obtained or obtainable by the method of fabricating the composition described above.

In another aspect, the present invention further relates to a method of fabricating a layer comprising at least, essentially consisting of or consisting of the following steps;
(I^{Y}) providing the composition of the present invention, preferably onto a substrate, a supporting layer or onto a layer of an electronic device;
(II^{Y}) heating the provided composition to form a layer, preferably to remove a solvent in the composition, preferably said heating is conducted at the temperature in the range from 60 to 140° C., more preferably in the range from 80 to 130° C.
(III^{Y}) optionally irradiating the provided composition with ultraviolet (UV) light to cure.

According to the present invention, said UV light is a light having peak light wavelength in the range from 250-450 nm.

In another aspect, present invention further relates to a layer obtained from the composition of the present invention by curing or obtained by the method of fabricating a layer explained above. Preferably said layer is a protection layer of an electric device. Preferably said curing is a heat curing and/or UV light curing.

In another aspect, the present invention further relates to a layer comprising at least, essentially consisting of or consisting of;
a polymer made from a polysiloxane; and
a chemical compound represented by following chemical formula (I). preferably it is a dielectric constant promoter preferably used for a polysiloxane containing composition,

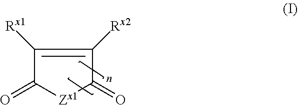

wherein
Z^{X1} is selected from the group consisting of a direct bond, CH₂, C═O, O, (C=O)₂, (C=O)O, (C=O)₃, (C=O)₂O, (C=O)₂CH₂ and C═O(CH₂)₂, preferably it is selected from a direct bond, C═O, O, (C=O)₂, (C=O)₃;
n is 0 or 1;
R^{x1} is H, D or OR^{x3};
R^{x2} is H, D or OR^{x3};
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, V⁺. Preferably said monovalent metal cation is Na⁺, Li⁺, K⁺, Cu⁺, Ag⁺, Au⁺, more preferably it is Na⁺, Li⁺, K⁺.

The detailed explanation of the chemical compound of formula (I) and polysiloxane, including the preferable amounts, are indicated above in the section of ii) Chemical compound of formula (I), and i) Polysiloxane.

In a preferred embodiment of the present invention, the dielectric constant (εᵣ) of the solid content of the layer is 3.5 or more, and 7 or less, preferably it is 3.9 or more, to 6.5, more preferably 4.0 or more, preferably it is 6.5 or less, more preferably 6 or less. Preferably it is in the range from 3.5 to 7, more preferably it is from 3.6 to 6.5, even more preferably from 4 to 6.

It is believed that above mentioned the dielectric constant (εᵣ) of the solid content of the layer realizes improved touch sensitivity of the layer like glass substrate when it is used as a protection layer of a device, namely an electronic device, such as OLED, LCD.

The dielectric constant of the layer is measured as described above in the section of Composition.

In a preferred embodiment of the present invention, the Haze value of the layer is less than 100%, preferably it is in the range from 0.01 to 10%, more preferably from 0.1 to 5%.

According to the present invention, said Haze value is measured at room temperature in air using a haze measurement system with an integrating sphere (NDH-7000, Nippon Denshoku, Japan, Light source White LED 3 W, wavelength range 380^{˜}780 nm). The sample thickness is between 2 μm and 700 μm. Particularly it is 700 μm.

Schematics of the integrating sphere for transmittance and haze measurement, the total transmittance (T_{T}) T_{T}=T_{P}+T_{D}, the haze (H) H=T_{D}/T_{T}.

The parallel transmittance (T_{P}) is determined by measuring the light intensity at a position opposite to that of the sample in the sphere, and the total transmittance (T_{T}), including the diffracted light transmittance (T_{D}) and T_{P}, is obtained by measuring the light passing through the sample, using the equation T_{T}=T_{P}+T_{D}. The degree of light scattering in the sample, i.e., the haze (H), is defined as H=T_{D}/T_{T}. The transmittance and haze is measured.

In another aspect, the present invention further relates to an electronic device comprising at least a layer of the present invention, preferably said electronic device comprises a light modulating or a light emitting layer, preferably said layer is placed onto the outermost surface of the electronic device. More preferably it is a light extraction side (viewing side) of the electronic device. Preferably said electronic device does not comprise a cover glass substrate and the layer is used instead of the cover glass substrate to realize a cover glass free electronic device with having good touch sensitivity, preferably with lower haze value.

In another aspect, the present invention further relates to a method of using the chemical compound of chemical formula (I) as a dielectric constant promoter in a polysiloxane containing composition.

In another aspect, the present invention further relates to a method of using of the composition of the present invention as a protection layer forming composition for an electronic device, preferably using the composition instead of an upper glass substrate of said electronic device.

### Preferable Embodiments

1. A composition, preferably being a protection layer forming composition, comprising at least, essentially consisting of or consisting of:
a polysiloxane; and
a chemical compound represented by following chemical formula (I), preferably it is a dielectric constant promoter preferably used for a polysiloxane containing composition,

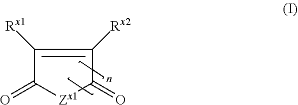

wherein
Z^{X1} is selected from the group consisting of a direct bond, CH₂, C═O, O, (C=O)₂, (C=O)O, (C=O)₃, (C=O)₂O, (C=O)₂CH₂ and C═O(CH₂)₂, preferably it is selected from a direct bond, C═O, O, (C=O)₂, (C=O)₃;
n is 0 or 1;
R^{x1} is H, D or OR^{x3};
R^{x2} is H, D or OR^{x3};
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, V*. Preferably said monovalent metal cation is Na⁺, Li⁺, K⁺, Cu⁺, Ag⁺, Au⁺, more preferably it is Na⁺, Li⁺, K⁺.

2. The composition of embodiment 1, wherein the molecular weight (Mw) of the chemical compound is 250 or less, preferably in the range from 30 to 250, more preferably from 100 to 200.

3. The composition of embodiment 1 or 2, wherein the total amount of the chemical compound of the formula (I) based on the total amount of the polysilazane in the composition is in the range from 0.01 to 40 wt %, preferably it is in the range from 0.1 to 20 wt %, more preferably from 0.3 to 5.0 wt %.

4. The composition of any one of the preceding embodiments, wherein the dielectric constant (εᵣ) of the solid content of the composition is 3.5 or more, and 7 or less, preferably it is 3.9 or more, to 6.5, more preferably 4.0 or more, preferably it is 6.5 or less, more preferably 6 or less.

Preferably said dielectric constant (εᵣ) of the solid content of the composition is measured by the following method:
1) Sample preparation and mesurement of dielectric constant
   Coating said composition on a conductive wafer selected from Al, Si or Mo;
   Putting electrodes on the coated composition using Ag or Al by sputtering or vapor deposition to form a sample;
   Measuring the dielectric constant of the sample by attaching of pin probers to the surface of the conductive wafer and the top electrode on coated composition respectively.
2) Measurement conditions; The dielectric constant is measured by LCR meter (E4980A, Agilent (Korea)/6440B, Toyo technical (Japan) with applying specific range of frequency (50^{˜}1 MHz) at room temperature and reading the capacitance indicated in the LCR meter. The value of dielectric constant is calculated by next equation, C=KA/d (C=Capacitance, K=Dielectric constant, A=Effective area of electrode, d=Distance between electrodes)

5. The composition of any one of the preceding embodiments,
Z^{X1} is selected from a direct bond, C═O, O, (C=O)₂, (C=O)₃;
n is 0 or 1;
R^{x1} is H or OR^{x3};
R^{x2} is H or OR^{x3};
R^{x3} is H, a non-substituted or substituted straight alkyl group having 1 to 3 carbon atoms or a monovalent metal cation selected from the group consisting of Na⁺, Li⁺, K⁺, Cu⁺, Ag⁺, Au⁺, more preferably it is Na⁺, Li⁺, K⁺;
preferably said chemical compound is an oxocabonic acid selected from deltic acid, squaric acid, croconic acud, rhodizonic acid or heptagonic acid, preferably said oxocabonic acid is squaric acid or Croconic acid; an oxocabonic acid derivative, preferably said oxocabonic acid derivative is 3,4-Dihydroxy-3-cyclobutene-1,2-dione (squaric acid diethyl ester); 3,4-Dibutoxy-3-cyclobutene-1,2-dione (squaric acid dibuthyl ester), croconic acid disodium salt, potassium rhodizonate; Maleic anhydride or a combination of any of them.

6. The composition of any one of the preceding embodiments, wherein the polysiloxane comprises a repeating unit of chemical formula (I^{a}).

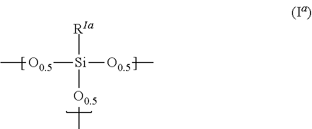

wherein
R¹ is hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group, the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced, or one or more methylene is replaced by oxy, imino or carbonyl, provided that R³ is neither hydroxy nor alkoxy.

7. The composition of any one of the preceding embodiments, wherein the polysiloxane comprises a repeating unit of chemical formula (I^{b}).

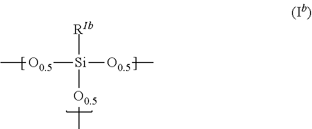

wherein
R^{Ib} is a group obtained by removing plural hydrogen from a nitrogen and/or oxygen-containing cycloaliphatic hydrocarbon compound having amino, imino and/or carbonyl,
R^{Ib} is preferably a group obtained by removing plural hydrogen, preferably two or three hydrogen, from preferably a nitrogen-containing aliphatic hydrocarbon ring having imino and/or carbonyl, more preferably a 5-membered or 6-membered ring containing nitrogen as a member. For example, groups obtained by removing two or three hydrogen from piperidine, pyrrolidine or isocyanurate. R^{Ib} connects Si each other included in plural repeating units.

8. The composition of any one of the preceding embodiments, wherein the polysiloxane comprises a repeating unit of chemical formula (I^{c}).

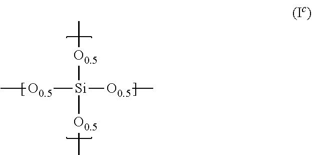

9. The composition of any one of the preceding embodiments, wherein the polysiloxane comprises a repeating unit of chemical formula (I^{d}).

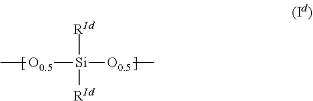

wherein
R^{Id} each independently represents hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group;
the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced or replaced with oxy, imide or carbonyl.

10. The composition of any one of the preceding embodiments, wherein the polysiloxane further comprises a repeating unit of chemical formula (I^{e}).

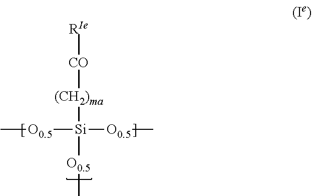

wherein
R^{Ie} is a linear alkyl group having 1-5 carbon atoms, a branched alkyl group having 3 to 7 carbon atoms, where one or more non adjacent CH₂ group of the linear alkyl group or the branched alkyl group may be replaced by C═CH₂, C═O, or OH or the terminal CH₃ group of said linear alkyl group having 1-5 carbon atoms or the branched alkyl group having 3 to 7 carbon atoms may be replaced with C═CH₃, preferably R^{Ie} is a linear alkyl group having 1-4 carbon atoms, a branched alkyl group having 3 to 5 carbon atoms, more preferably it is a branched alkyl group having 3 to 5 carbon atoms, furthermore preferably it is a branched alkyl group having 3 carbon atoms,
more preferably at least one of CH₂ groups of said linear alkyl group having 1-5 carbon atoms or the branched alkyl group having 3 to 7 carbon atoms is replaced by C═CH₂ or the terminal CH₃ group of said linear alkyl group having 1-5 carbon atoms or the branched alkyl group having 3 to 7 carbon atoms may be replaced with C═CH₃, furthermore preferably R^{Ie} is C═CH₃ or C═CH₂—CH₃,
the most preferably, said chemical formula (I^{e}) is

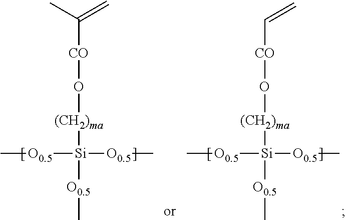

ma is each independently an integer of 1 to 6, preferably it is 2 to 5, more preferably it is 3.

11. The composition of any one of the preceding embodiments, the composition further comprises an additive.

12. The composition of any one of the preceding embodiments, further comprises a solvent. Preferably said solvent is selected from one or more members of the group consisting of propylene glycol monomethyl ether acetate, propylene glycol monomethyl ether, propylene glycol diacetate, diethylene glycol monohexyl ether and methyl 3-methoxypropionate, methyl isobutyl ketone, methyl ethyl ketone, amine type solvent preferably selected from one or more members of the group consisting of N-Methylpyrrlidone (NMP), 3-Methoxy-N,N-dimethylpropanamide, N,N-dimethylacetamide (DMA), N,N-dimethylformamide (DMF), dimethyl sulfoxide (DMSO), acetonitrile, more preferably it is N-Methylpyrrlidone (NMP) or 3-Methoxy-N,N-dimethylpropanamide.

13. A method of fabricating the composition of any one of the preceding embodiments, comprising at least, essentially consisting of or consisting of; the following step:
(I^{x}) mixing a polysiloxane; and
a chemical compound represented by following chemical formula (I). preferably it is a dielectric constant promoter preferably used for a polysiloxane containing composition,

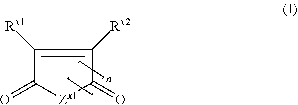

wherein
Z^{X1} is selected from the group consisting of a direct bond, CH₂, C═O, O, (C=O)₂, (C=O)O, (C=O)₃, (C=O)₂O, (C=O)₂CH₂ and C═O(CH₂)₂, preferably it is selected from a direct bond, C═O, O, (C=O)₂, (C=O)₃;
n is 0 or 1;
R^{x1} is H, D or OR^{x3};
R^{x2} is H, D or OR^{x3};
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, V*. Preferably said monovalent metal cation is Na⁺, Li⁺, K⁺, Cu⁺, Ag⁺, Au⁺, more preferably it is Na⁺, Li⁺, K⁺.

14. A composition obtained or obtainable by the method of embodiment 13.

15. A method of fabricating a layer comprising at least the following steps;
(I^{Y}) providing the composition of any one of embodiments 1-12 and 14, preferably onto a substrate, a supporting layer or onto a layer of an electronic device;
(II^{Y}) heating the provided composition to form a layer, preferably to remove a solvent in the composition, preferably said heating is conducted at the temperature in the range from 60 to 140° C., more preferably in the range from 80 to 130° C.

16. A layer obtained from the composition of any one of the embodiments 1 to 12 and 14 by curing or obtained by the method of embodiment 15. Preferably said layer is a protection layer of an electric device. Preferably said curing is a heat curing.

17. A layer comprising at least;
a polymer made from a polysiloxane; and
a chemical compound represented by following chemical formula (I). preferably it is a dielectric constant promoter preferably used for a polysiloxane containing composition,

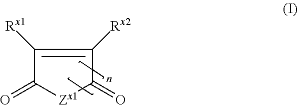

wherein
Z^{X1} is selected from the group consisting of a direct bond, CH₂, C═O, O, (C═O)₂, (C=O)O, (C=O)₃, (C=O)₂O, (C=O)₂CH₂ and C═O(CH₂)₂, preferably it is selected from a direct bond, C═O, O, (C═O)₂, (C=O)₃;
n is 0 or 1;
R^{x1} is H, D or OR^{x3};
R^{x2} is H, D or OR^{x3};
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, V⁺. Preferably said monovalent metal cation is Na⁺, Li⁺, K⁺, Cu⁺, Ag⁺, Au⁺, more preferably it is Na⁺, Li⁺, K⁺.

18. The layer of embodiment 16 or 17, wherein the dielectric constant (εᵣ) of the solid content of the layer is 3.5 or more, and 7 or less, preferably it is 3.9 or more, to 6.5, more preferably 4.0 or more, preferably it is 6.5 or less, more preferably 6 or less. Preferably it is in the range from 3.5 to 7, more preferably it is from 3.6 to 6.5, even more preferably from 4 to 6.

19. The layer of any one of the embodiments 16-18, wherein the Haze value of the layer is less than 100%, preferably it is in the range from 0.01 to 10%, more preferably from 0.1 to 5%.
wherein said Haze value is measured at room temperature in air using a haze measurement system with an integrating sphere (NDH-7000, Nippon Denshoku, Japan, Light source White LED 3 W, wavelength range 380^{˜}780 nm).

Schematics of the integrating sphere for transmittance and haze measurement, the total transmittance (T_{T}) T_{T}=T_{P}+T_{D}, the haze (H) H=T_{D}/T_{T}.

The parallel transmittance (T_{P}) is determined by measuring the light intensity at a position opposite to that of the sample in the sphere, and the total transmittance (T_{T}), including the diffracted light transmittance (T_{D}) and T_{P}, is obtained by measuring the light passing through the sample, using the equation T_{T}=T_{P}+T_{D}. The degree of light scattering in the sample, i.e., the haze (H), is defined as H=T_{D}/T_{T}. The transmittance and haze is measured.

20. An electronic device comprising at least a layer of any one of embodiments 16-19, preferably said electronic device comprises a light modulating or a light emitting layer, preferably said layer is placed onto the outermost surface of the electronic device. More preferably it is an light extraction side (viewing side) of the electronic device.

21. Method of using the chemical compound of chemical formula (I) as a dielectric constant promoter in a polysiloxane containing composition.

22. Method of using of the composition of any one of the embodiments 1 to 12 and 14 as a protection layer forming composition for an electronic device, preferably using the composition instead of an upper glass substrate of said electronic device.

### Technical Effects of the Invention

The present invention provides one or more of the following technical effects:
obtaining a polysiloxane containing composition, preferably being a protection layer forming composition, showing an improved dielectric constant like glass substrate of an electronic device, preferably with lowest haze property; obtaining a layer or cured composition, showing an improved dielectric constant like glass substrate of an electronic device, preferably with lowest haze property; obtaining a polysiloxane containing composition, preferably being a protection layer forming composition, enabling sufficient amount of thiol well dispersed in the composition; obtaining a layer or cured composition, in which sufficient amount of thiol well dispersed in the layer or cured composition; obtaining a polysiloxane containing composition, preferably being a protection layer forming composition, enabling mild or lower temperature process to form a layer or cured composition, smooth coating of polysiloxane containing composition onto any substrate, namely onto PET, CPI, COP or a polarizer.

### Working Examples

The working examples below provide descriptions of the present invention, as well as an in-detail description of their fabrication. However, the present invention is not limited to these working examples.

### Working Example 1: Mixture Sample Preparation

Polysiloxane polymer from Merck represented by following chemical formula is mixed with 0.5 wt % (Sample 1-1), 1 w % (Sample 1-2) and 2 w % (Sample 1-3) of Squaric acid as the chemical compound of formula (I) based on the total amount of polysiloxane in the presence of the mixture of propyleneglycol monomethyl ether acetate and NMP (N-Methylpyrrlidone) (total weight of said siloxane polymer and the chemical compound of formula (I):solvent mixture=3:7). After mixing above compounds, it is coated onto an Al deposited silicone wafer by spin coating each separately to obtain samples. Then, the solvent mixture is evaporated at 120° C. of curing process to obtain samples 1-1 (0.5 wt % squaric acid)), 1-2 (1 wt % squaric acid)) and 1-3(2 wt % squaric acid).

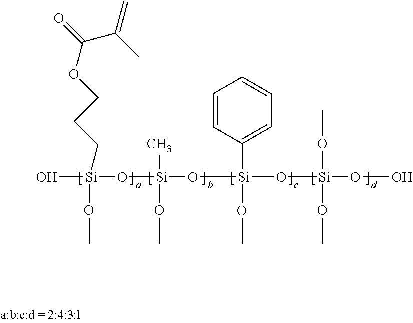

### Working Examples 2 to 4: Mixture Sample Preparation

Working examples 2 to 4 are performed in the same manner as described in working example 1 except for that the chemical compound listed below is used instead of Squaric acid. Then samples containing 0.5 wt % chemical compound (sample 2-1, 3-1, 4-1), samples containing 1 wt % chemical compound (sample 2-2, 3-2, 4-2) and samples containing 2 wt % chemical compound (sample 2-3, 3-3, 4-3) are obtained in each working examples.

Chemical compounds represented by chemical formula (I) used in the working examples 1 to 4
Comparative example 1: no thiol containing compound is used
Working Example 1: Squaric acid
Working Example 2: 3,4-Dihydroxy-3-cyclobutene-1,2-dione
Working Example 3: Croconic acid
Working Example 4: maleic anhydride

### Comparative Example 1: Reference Sample Preparation

Reference sample is prepared in the same manner as described in working example 1 except for that no chemical compound of formula (I) is added/mixed with the siloxane polymer and as the siloxane polymer, following polymer is used. Then reference sample 1 is obtained.

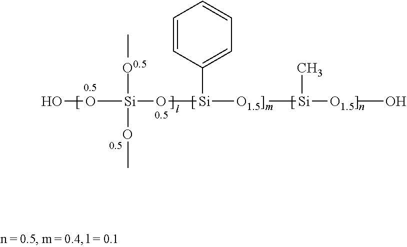

### Comparative Example 2: Reference Sample Preparation

Reference sample is prepared in the same manner as described in working example 1 except for that no chemical compound of formula (I) is added/mixed with the siloxane polymer. Then reference sample 2 is obtained.

### Working Example 5: Measurement of Dielectric Constant of the Samples from Working Examples 1 to 4 and Comparative Example 1

The dielectric constant is measured by LCR meter (E4980A, Agilent (Korea)/6440B, Toyo technical (Japan) with applying specific range of frequency (50˜1 MHz) at room temperature and reading the capacitance indicated in the LCR meter. The value of dielectric constant is calculated by next equation, C=KA/d (C=Capacitance, K=Dielectric constant, A=Effective area of electrode, d=Distance between electrodes)

Following table 1 show the results of the measurements.

TABLE 1

| | | Wt. % of the | |
|---|---|---|---|
| | Chemical compound of | Chemical | dielectric |
| Sample name | formula (I) | compound | constant |
| Reference 1 | No compound | 0 | 3.40 |
| Reference 2 | No compound | 0 | 3.50 |
| Sample 1-1 | Squaric acid | 0.5 | 3.94 |
| Sample 1-2 | Squaric acid | 1 | 3.92 |
| Sample 1-3 | Squaric acid | 2 | 4.04 |
| Sample 2-1 | 3,4-Dihydroxy-3- | 0.5 | 4.28 |
| | cyclobutene-1,2-dione | | |
| Sample 2-2 | 3,4-Dihydroxy-3- | 1 | 4.30 |
| | cyclobutene-1,2-dione | | |
| Sample 2-3 | 3,4-Dihydroxy-3- | 2 | 4.37 |
| | cyclobutene-1,2-dione | | |
| Sample 3-1 | Croconic acid | 0.5 | 4.04 |
| Sample 3-2 | Croconic acid | 1 | 4.24 |
| Sample 3-3 | Croconic acid | 2 | 4.37 |
| Sample 4-1 | maleic anyhydride | 0.5 | 4.04 |
| Sample 4-2 | maleic anyhydride | 1 | 4.24 |
| Sample 4-3 | maleic anyhydride | 2 | 4.37 |

As shown above table 1, the chemical compounds of formula (I), preferably the chemical compounds used in samples 1 to 4, increase the dielectric constant of the polysiloxane composition dramatically. And it is believed that it can help touch sensitivity for glass free electronic devices such as touch glass free OILED concept.

1. A composition, comprising:
i) a polysiloxane; and
ii) a chemical compound represented by the following chemical formula (I), 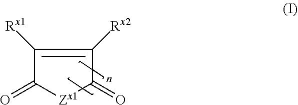
wherein
Z^{X1} is selected from the group consisting of a direct bond, CH₂, C═O, O, (C=O)₂, (C=O)O, (C=O)₃, (C=O)₂O, (C=O)₂CH₂, and C═O(CH₂)₂;
n is 0 or 1;
R^{x1} is H, D or OR^{x3};
R^{x2} is H, D or OR^{x3}; and
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, and V*.

2. The composition of claim 1, wherein the chemical compound represented by formula (I) is a dielectric promoter used for a polysiloxane containing composition.

3. The composition of claim 1, wherein Z^{X1} is selected from the group consisting of a direct bond, C═O, O, (C=O)₂, and (C=O)₃.

4. The composition of claim 1, wherein the monovalent metal cation is selected from the group consisting of Na⁺, Li⁺, K⁺, Cu⁺, Ag⁺, and Au⁺.

5. The composition of claim 1, wherein the molecular weight (Mw) of the chemical compound is 250 or less.

6. The composition of claim 1, wherein the total amount of the chemical compound based on the total amount of the polysilazane in the composition is in the range from 0.01 to 40 wt %.

7. The composition of claim 1, wherein the dielectric constant (εᵣ) of the solid content of the composition is 3.5 or more, and 7 or less.

8. The composition of claim 1, wherein:
Z^{X1} is selected from a direct bond, C═O, O, (C=O)₂, and (C=O)₃;
n is 0 or 1;
R^{x1} is H or OR^{x3};
R^{x2} is H or OR^{x3}; and
R^{x3} is H, a non-substituted or substituted straight alkyl group having 1 to 3 carbon atoms or a monovalent metal cation selected from the group consisting of Na⁺, Li⁺, K⁺, Cu⁺, Ag⁺, and Au⁺.

9. The composition of claim 8, wherein said chemical compound is an oxocabonic acid selected from the group consisting of deltic acid, squaric acid, croconic acid, rhodizonic acid, and heptagonic acid, or an oxocabonic acid derivative selected from the group consisting of 3,4-Dihydroxy-3-cyclobutene-1,2-dione (squaric acid diethyl ester); 3,4-Dibutoxy-3-cyclobutene-1,2-dione (squaric acid dibuthyl ester), croconic acid disodium salt, potassium rhodizonate, Maleic anhydride, and a combination of any of them.

10. The composition of claim 1, wherein the polysiloxane comprises a repeating unit of chemical formula (I^{a}), 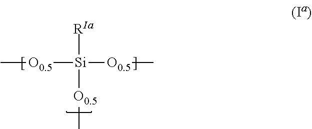
wherein
R^{Ia} is hydrogen, a C₁₋₃₀ linear, C₃₋₃₀ branched or cyclic, saturated or unsaturated, aliphatic hydrocarbon group or aromatic hydrocarbon group, the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced, or one or more methylene is replaced by oxy, imino or carbonyl, provided that R^{Ia} is neither hydroxy nor alkoxy.

11. The composition of claim 1, wherein the polysiloxane comprises a repeating unit of chemical formula (I^{b}), 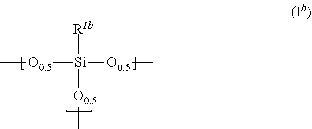
wherein
R^{Ib} is a group obtained by removing plural hydrogen from a nitrogen and/or oxygen-containing cycloaliphatic hydrocarbon compound having amino, imino and/or carbonyl.

12. The composition of claim 1, further comprising a solvent.

13. A method of fabricating the composition of claim 1, comprising the step of:
(I^{x}) mixing a polysiloxane and a chemical compound represented by the following chemical formula (I), 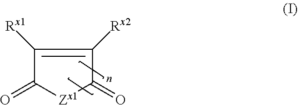
wherein
Z^{X1} is selected from the group consisting of a direct bond, CH₂, C═O, O, (C=O)₂, (C═O)O, (C=O)₃, (C=O)₂O, (C=O)₂CH₂, and C═O(CH₂)₂;
n is 0 or 1;
R^{x1} is H, D or OR^{x3};
R^{x2} is H, D or OR^{x3}; and
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, and V⁺.

14. A method of fabricating a layer comprising the following steps:
(I^{Y}) providing the composition of claim 1; and
(II^{Y}) heating the provided composition to form a layer.

15. The method of claim 14, wherein the composition is heated to remove solvent in the composition, and optionally, wherein said heating is conducted at a temperature in the range of 60 to 140° C.

16. A layer obtained by the method of claim 14.

17. A layer comprising:
i) a polymer made from a polysiloxane; and
ii) a chemical compound represented by the following chemical formula (I), 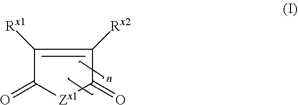
wherein
Z^{X1} is selected from the group consisting of a direct bond, CH₂, C═O, O, (C=O)₂, (C=O)O, (C=O)₃, (C=O)₂O, (C=O)₂CH₂, and C═O(CH₂)₂;
n is 0 or 1;
R^{x1} is H, D or OR^{x3};
R^{x2} is H, D or OR^{x3}; and
R^{x3} is H, D, a non-substituted or substituted straight alkyl group having 1 to 5 carbon atoms, a non-substituted or substituted branched alkyl group having 3 to 5 carbon atoms or a monovalent metal cation selected from the group consisting of Na⁺, Li⁺, K⁺, Rb⁺, Cs⁺, Fr⁺, Cu⁺, Ag⁺, Au⁺, Ti⁺, Pd⁺, Ni⁺, Mn⁺, Cr⁺, and V⁺.

18. The layer of claim 17, wherein the dielectric constant (εᵣ) of the solid content of the layer is 3.5 or more, and 7 or less.

19. The layer of claim 17, wherein the Haze value of the layer is less than 100%.

20. An electronic device comprising at least a layer of claim 17.
